(19) United States
(12) Patent Application Publication
(10) Pub. No.: US 2025/0206634 A1
(43) Pub. Date: Jun. 26, 2025

(54) METHOD FOR RECOVERING MOLYBDENUM COMPOUND

(71) Applicant: DIC Corporation, Tokyo (JP)

(72) Inventors: Minoru Tabuchi, Sakura-shi (JP); Naoto Yagi, Sakura-shi (JP); Jianjun Yuan, Sakura-shi (JP)

(73) Assignee: DIC Corporation, Tokyo (JP)

(21) Appl. No.: 18/975,226

(22) Filed: Dec. 10, 2024

(30) Foreign Application Priority Data
Dec. 26, 2023 (JP) 2023-218935

(51) Int. Cl. C01G 39/02

(52) U.S. Cl. CPC C01G 39/02; C01P 2006/12; C01P 2006/80

(57) ABSTRACT

To provide a method for recovering a molybdenum compound that can obtain molybdenum oxide powder having a high purity and a large specific surface area from a molybdenum component-containing solution. The method including: precipitating, in a molybdenum component-containing solution, a molybdate represented by AₓMo_{y}O_{3y+z} (1) (in the formula (1), A represents an element selected from Group 4, Group 8, Group 12, Group 13, and Group 14; 3y+z represents the number of oxygen atoms contained in the molybdate; and z represents the number of ½ the valence number of A×x); firing including producing an oxide represented by AO_{z} (2) (in the formula (2), A is the same as A in the formula (1); and z represents the number of oxygen atoms that combine with A in the formula (2) to produce an oxide) and producing vapor containing molybdenum trioxide, by thermally decomposing the molybdate; cooling; and recovering.

### BACKGROUND OF THE INVENTION

### 1. Field of the Invention

The present invention relates to a method for recovering a molybdenum compound.

### 2. Description of the Related Art

Conventionally, molybdenum compounds such as molybdenum trioxide have been suitably used as a flux in the production for inorganic oxides such as alumina, zirconia, titania, and silica using a flux method. In addition, the molybdenum compounds have been also widely used as a catalyst.

However, molybdenum that is a raw material for the molybdenum compounds, is an expensive as well as price-volatile element. For this reason, a method for reusing the molybdenum compounds recovered from a waste liquid containing molybdenum as a raw material is being considered.

A method for recovering molybdenum used to recover molybdenum from used catalysts or the like containing molybdenum includes, for example, the method described in Japanese Unexamined Patent Application Publication No. 2013-007107.

Japanese Unexamined Patent Application Publication No. 2013-007107 describes the method for recovering molybdenum from a treatment solution, which is an aqueous solution containing molybdenum. In the method for recovering molybdenum described in Japanese Unexamined Patent Application Publication No. 2013-007107, an extraction process for extracting molybdenum by performing a solvent extraction with a treatment solution, a back-extraction process for back-extracting the extraction solvent obtained in the extraction process, and a recovering process for recovering molybdenum as a deposition of a molybdate by adding acid to the back-extracted solution obtained in the back-extraction process, are performed in this order.

### SUMMARY OF THE INVENTION

In recent years, a demand for molybdenum oxide powder having a high purity and a large specific surface area has been increasing among the molybdenum compounds.

However, it has been difficult to obtain molybdenum oxide powder having a high purity and a large specific surface area from a molybdenum component-containing solution such as a waste liquid containing molybdenum, using a conventional method for recovering a molybdenum compound. Therefore, the recovered molybdenum oxide powder had few reusable applications.

The present invention was made in view of the above circumstances, and an object is to provide a method for recovering a molybdenum compound, which can obtain molybdenum oxide powder having a high purity and a large specific surface area, from a molybdenum component-containing solution.

[1]A method for recovering a molybdenum compound, the method including:
precipitating, in a molybdenum component-containing solution, a molybdate represented by AₓMo_{y}O_{3y+z} (1) (in the formula (1), A represents an element selected from Group 4, Group 8, Group 12, Group 13, and Group 14; 3y+z represents the number of oxygen atoms contained in the molybdate; and z represents the number of ½ the valence number of A×x);
firing including producing an oxide represented by AO_{z}(2) (in the formula (2), A is the same as A in the formula (1); and z represents the number of oxygen atoms that combine with A in the formula (2) to produce an oxide) and producing vapor containing molybdenum trioxide, by thermally decomposing the molybdate;
cooling the vapor containing molybdenum trioxide to produce powder containing molybdenum trioxide; and
recovering the powder containing molybdenum trioxide.

[2] The method for recovering a molybdenum compound according to [1], in which, in the precipitating, a precipitation accelerator containing a compound containing one or more kinds of elements selected from Group 4, Group 8, Group 12, Group 13, and Group 14 elements is added to the molybdenum component-containing solution and a resultant mixture is stirred to precipitate the molybdate.

[3] The method for recovering a molybdenum compound according to [1], in which, in the precipitating, a precipitation accelerator containing an aluminum compound is added to the molybdenum component-containing solution and a resultant mixture is stirred to precipitate the molybdate.

[4] The method for recovering a molybdenum compound according to [1], in which, in the precipitating, a precipitation accelerator containing polyaluminum chloride is added to the molybdenum component-containing solution and a resultant mixture is stirred to precipitate the molybdate.

[5] The method for recovering a molybdenum compound according to [4], in which a pH of the molybdenum component-containing solution to which a precipitation accelerator containing polyaluminum chloride is added is adjusted to be in a range of 8 to 13.

[6] The method for recovering a molybdenum compound according to [1], in which, in the recovering, molybdenum trioxide powder having a purity of 99% or more and a specific surface area of 20 m²/g or more as measured by the BET method is recovered.

### DETAILED DESCRIPTION OF EMBODIMENTS

In order to solve the above problem and obtain molybdenum oxide powder having a high purity and a large specific surface area from a molybdenum component-containing solution, the present inventors have focused on the fact that powder produced by cooling vapor containing molybdenum trioxide has a high purity and a large specific surface area as measured by the BET method, and have made intensive studies.

As a result, the present inventors have found that, it is only required to precipitate, in a molybdenum component-containing solution, a molybdate represented by AₓMo_{y}O_{3y+z} (1) (in the formula (1), A represents an element selected from Group 4, Group 8, Group 12, Group 13, and Group 14; 3y+z represents the number of oxygen atoms contained in the molybdate; and z represents the number of ½ the valence number of A×x), and to produce an oxide represented by AO_{z}(2) (in the formula (2), A is the same as A in the formula (1); and z represents the number of oxygen atoms that combine with A in the formula (2) to produce an oxide.) and produce the vapor containing molybdenum trioxide, by thermally decomposing the obtained molybdate.

Furthermore, the present inventors have found that by precipitating a molybdate represented by the formula (1) in a molybdenum component-containing solution, thermally decomposing the obtained precipitate to produce the vapor containing molybdenum trioxide, cooling the obtained vapor to produce powder, and recovering the obtained powder, powder containing molybdenum trioxide having a high purity and a large specific surface area as measured by the BET method can be obtained, leading to the conception of the present invention.

Hereinafter, a method for recovering a molybdenum compound of the present invention will be described in detail. The scope of the present invention is not limited to one embodiment described herein, and various modifications can be made without departing from the spirit of the present invention. In addition, in a case where a plurality of upper and lower limit values are listed for a specific parameter, among these upper and lower limit values, any of these upper and lower limit values can be combined to set a suitable numerical range.

The method of recovering a molybdenum compound of the present embodiment has a precipitating process, a firing process, a cooling process, and a recovering process. The method of recovering a molybdenum compound of the present embodiment may be carried out in a batch or continuous manner.

In the method of recovering a molybdenum compound of the present embodiment, powder containing molybdenum trioxide is recovered from a molybdenum component-containing solution. The molybdenum component-containing solution is a solution in which a component containing a molybdenum component is dispersed or dissolved in a medium.

The molybdenum component contained in the molybdenum component-containing solution can be any component that can be dissolved in the molybdenum component-containing solution, such as potassium molybdate, sodium molybdate, and lithium molybdate.

A medium contained in the molybdenum component-containing solution may be an aqueous medium such as water and brine, may be an organic medium such as methanol, ethanol, and ethylene glycol, or may be one containing an aqueous medium and an organic medium.

The molybdenum component-containing solution may be a waste liquid containing molybdenum generated by washing the powder containing the molybdenum compound.

### (Precipitating Process)

In a precipitating process in the method of recovering a molybdenum compound of the present embodiment, in the molybdenum component-containing solution, a molybdate represented by AₓMo_{y}O_{3y+z} (1) (in the formula (1), A represents an element selected from Group 4, Group 8, Group 12, Group 13, and Group 14; 3y+z represents the number of oxygen atoms contained in the molybdate; and z represents the number of ½ the valence number of A×x) is precipitated. The molybdate represented by the formula (1) that is precipitated in the molybdenum component-containing solution may be of only one kind or of two or more kinds.

A in the molybdate represented by the formula (1) to be precipitated in the precipitating process is an element selected from Group 4, Group 8, Group 12, Group 13, and Group 14 elements, and is an element that can react with molybdenum oxide and/or molybdic acid to produce the molybdenum compound.

Examples of Group 4 elements include titanium, zirconium, and hafnium. Examples of Group 8 elements include iron and ruthenium. Examples of Group 12 elements include zinc. Examples of Group 13 elements include aluminum, gallium, and indium. Examples of Group 14 elements include silicon, germanium, and tin.

Specifically, the molybdate represented by the formula (1) is preferably one kind or two or more kinds of molybdates selected from Ti(MoO₄)₂ in which A in the formula (1) is a Group 4 element; FeMoO₄ and Fe₂(MoO₄)₃ in which A in the formula (1) is a Group 8 element; ZnMoO₄ in which A in the formula (1) is a Group 12 element; Al₂(MoO₄)₃ in which A in the formula (1) is a Group 13 element; and Si(MoO₄)₂ in which A in the formula (1) is a Group 14 element.

These molybdates can be thermally decomposed at a temperature of 1,300° C. or lower. Therefore, in a firing process described below, the molybdate represented by the formula (1) can be easily thermally decomposed, and vapor containing molybdenum trioxide can easily be produced.

In the precipitating process, among the above molybdates, a compound in which A in the formula (1) is aluminum is preferably precipitated, and aluminum molybdate (Al₂(MoO₄)₃) is especially preferably precipitated. In a case where A in the formula (1) is aluminum, the molybdate is thermally decomposed in the firing process described below to produce aluminum oxide containing alumina (Al₂O₃) and the molybdenum compound containing molybdenum trioxide (MoO₃), and the molybdenum trioxide is vaporized. Molybdenum trioxide in a thermally decomposed material containing aluminum oxide in a solid state is unlikely to remain in the thermally decomposed material and easily turns into vapor to be separated from the thermally decomposed material. Therefore, in a case where A in the formula (1) is aluminum, the powder containing molybdenum trioxide can be recovered at a high recovery rate, which is thus preferable.

3y+z in the molybdate represented by the formula (1) represents the number of oxygen atoms contained in the molybdate and z represents the number of ½ the valence number of A×x. Thus, x in the formula (1) is determined according to the kind of A in the formula (1).

The precipitating process is preferably a process in which a precipitation accelerator is added to the molybdenum component-containing solution while stirring using a well-known method, and the solution is further stirred to precipitate the molybdate.

The precipitation accelerator is only required to contain a compound that reacts with the molybdenum component contained in the molybdenum component-containing solution to produce the molybdate, and can appropriately be determined according to the kind of the molybdenum component-containing solution and the kind of molybdate to be precipitated in the precipitating process.

As a precipitation accelerator, in the precipitating process, in order to precipitate the molybdate in which A in the formula (1) is an element selected from Group 4, Group 8, Group 12, Group 13, and Group 14 as the molybdate represented by the formula (1), the precipitation accelerator containing a compound containing the element corresponding to A in the formula (1) is used. Specific examples of the compounds containing an element selected from Group 4, Group 8, Group 12, Group 13, and Group 14 elements include TiCl₄, TiOSO₄, Ti(C₃H₈)₄, Zr(C₄H₉)₄, ZrOCl₂, ZrO(CH₃COO)₂, FeCl₂, FeCl₃, Zn(CH₃COO)₂, ZnCl₂, AlCl₃, Al(NO₃)₃, Al₂(SO₄)₃, [Al₂(OH)ₙCl₆₋ₙ]ₘ, SiCl₄, Si(OCH₃)₄, and Si(OC₂H₅)₄.

In addition, for example, in the precipitating process, in a case where the molybdate in which A in the formula (1) is aluminum is precipitated as the molybdate represented by the formula (1), the precipitation accelerator containing an aluminum compound is preferably used. Specific examples of the precipitation accelerators containing the aluminum compound include a precipitation accelerator containing a compound such as polyaluminum chloride ([Al₂(OH)ₙC₆₋ₙ]ₘ), aluminum chloride (AlCl₃), aluminum nitrate (Al(NO₃)₃), and aluminum sulfate (Al₂(SO₄)₃), and in particular, the precipitation accelerator containing polyaluminum chloride is preferably used. The reason is that aluminum molybdate (Al₂(MoO₄)₃) can be efficiently precipitated as the molybdate represented by the formula (1), and the molybdate represented by the formula (1) is thermally decomposed in the firing process described below to easily produce a high-purity vapor containing molybdenum trioxide. In addition, polyaluminum chloride is an inexpensive substance used as a flocculant in a water treatment, is highly stable and safe, and is easy to handle, which is thus preferable.

In a case where the precipitation accelerator containing polyaluminum chloride is used as the precipitation accelerator, the pH of the molybdenum component-containing solution to which the precipitation accelerator containing polyaluminum chloride is added is preferably adjusted to be in a range of 8 to 13. The reason for this is that the aluminum ions supplied from polyaluminum chloride to the molybdenum component-containing solution easily combine with the molybdenum component contained in the molybdenum component-containing solution. As a result, the precipitation of aluminum molybdate that is the molybdate represented by the formula (1), is accelerated, and the molybdenum component in the molybdenum component-containing solution can be recovered at a higher recovery rate.

As a method for adjusting the pH of the molybdenum component-containing solution to which the precipitation accelerator containing polyaluminum chloride is added to be in a range of 8 to 13, and a method for adding a well-known pH adjuster to the molybdenum component-containing solution and stirring the obtained solution, or the like can be used. As the pH adjuster, for example, potassium hydroxide, sodium hydroxide, lithium hydroxide, ammonia water, tetraethylammonium hydroxide, or the like can be used. The kind and the used amount of the pH adjuster can appropriately be determined, according to the composition and pH of the molybdenum component-containing solution.

The molybdate represented by the formula (1) precipitated in the molybdenum component-containing solution in the precipitating process is preferably recovered from the molybdenum component-containing solution by a well-known method. As a method for recovering the molybdate represented by the formula (1), for example, a method for filtering the molybdenum component-containing solution and separating the molybdate from the medium, or the like can be used. It is preferable that the molybdate represented by the formula (1) recovered from the molybdenum component-containing solution is dried by a well-known method to make into the powder and the obtained powder is then used in the firing process.

### (Firing Process)

In the firing process in the method of recovering the molybdenum compound of the present embodiment, the molybdate represented by the formula (1) that is precipitated in the precipitating process is thermally decomposed. As a heating method for thermally decomposing the molybdate represented by the formula (1), well-known methods can be used. In the present embodiment, a method in which the molybdate represented by the formula (1), which is recovered from the molybdenum component-containing solution and made into the powder, is placed in a heat treatment furnace and heated to thermally decompose it, is used.

In the firing process, the molybdate represented by the formula (1) is thermally decomposed to produce the oxide represented by AO_{z} (2) (in the formula (2), A is the same as A in the formula (1); and z represents the number of oxygen atoms that combine with A in the formula (2) to produce an oxide) and to produce vapor containing molybdenum trioxide.

z in the oxide represented by the formula (2) represents the number of oxygen atoms that combine with A in the formula (2) to produce the oxide, and is determined according to the kind of A in the formula (2) and the like.

In the firing process, the firing conditions for thermally decomposing the molybdate represented by the formula (1) only requires a temperature range that is equal to or higher than the temperature at which molybdenum trioxide can be vaporized and lower than the temperature at which the oxide represented by the formula (2) melts, and can appropriately be determined, according to the kind (composition), the amount, and the like of the molybdate represented by the formula (1).

For example, in a case where the molybdate represented by the formula (1) is aluminum molybdate (Al₂(MoO₄)₃), the firing conditions can be set to in an air atmosphere at normal pressure at a temperature of 900° C. to 1,300° C. for 1 to 48 hours.

In the firing process, when the molybdate represented by the formula (1) is thermally decomposed, the thermal decomposition can be performed by any heating profile, and the profile can appropriately be determined, according to the kind (composition), the amount, and the like of the molybdate represented by the formula (1).

In other words, when the molybdate represented by the formula (1) is thermally decomposed, the heating temperature can be varied by continuously or stepwise raising or decreasing the temperature within a predetermined temperature range, or the heating temperature may be maintained within a predetermined temperature range for a certain time. For example, the temperature can be raised from room temperature at a constant temperature rising rate, maintained at a predetermined temperature for a certain time, and then decreased to room temperature at a constant temperature decreasing rate.

### (Cooling Process)

The vapor containing molybdenum trioxide produced in the firing process is cooled using a well-known method in the cooling process to produce the powder containing molybdenum trioxide.

In the present embodiment, in the firing process, the vapor containing molybdenum trioxide produced in the heat treatment furnace is preferably discharged from the heat treatment furnace by a well-known method, supplied to a cooling pipe, and cooled in the cooling pipe to make into the powder.

As a method for cooling the vapor containing molybdenum trioxide in the cooling pipe, for example, the vapor can be cooled by well-known methods such as a method for blowing cooled gas into the cooling pipe and a method for cooling the outside of the cooling pipe with a cooling device.

The cooling rate at which the vapor containing molybdenum trioxide is cooled is, for example, in a temperature range of the highest temperature when the molybdate represented by the formula (1) is thermally decomposed to 800° C., at which molybdenum trioxide is solidified, preferably in a range of 500° C./second to 10,000° C./second and more preferably in a range of 1,000° C./second to 10,000° C./second. When the cooling rate of the vapor containing molybdenum trioxide in the temperature range of the highest temperature to 800° C. described above is 500° C./second or more, it is easier to obtain the molybdenum trioxide powder having a smaller particle diameter and the molybdenum trioxide powder having a larger specific surface area as measured by the BET method can be obtained. In addition, when the cooling rate of the vapor containing molybdenum trioxide in the temperature range of the highest temperature to 800° C. described above is 1,000° C./second or more, the cooling process can effectively be performed, which is thus more preferable.

### (Recovering Process)

The power containing molybdenum trioxide produced in the cooling process is recovered in the recovering process. As the method for recovering the powder containing molybdenum trioxide, recovering can be performed using well-known recovering means.

The powder containing molybdenum trioxide recovered from the molybdenum component-containing solution by the method for recovering a molybdenum compound in the present embodiment is produced by precipitating molybdate represented by the formula (1) in the molybdenum component-containing solution (precipitating process), thermally decomposing the obtained precipitate to produce the oxide represented by the formula (2) and produce the vapor containing molybdenum trioxide (firing process), cooling the vapor containing molybdenum trioxide to produce the powder (cooling process), and then recovering the obtained powder (recovering process). Therefore, the obtained powder is the molybdenum trioxide powder having a high purity and a large specific surface area as measured by the BET method.

Specifically, by using the method for recovering the molybdenum compound of the present embodiment, the molybdenum trioxide powder having a purity of 99% or higher and a specific surface area of 20 m²/g or more as measured by the BET method, can be recovered. By the method for recovering the molybdenum compound of the present embodiment, molybdenum trioxide powder having an average particle diameter of the primary particle of 70 nm or less can also be recovered.

In this specification, the average particle diameter of the primary particles of the molybdenum oxide powder is a numerical value measured and calculated by the method <1> or <2> described below.

<1> The scanning electron microscope (SEM) and/or the transmission electron microscope (TEM) is used to observe the particles of molybdenum trioxide powder at a magnification of 100,000 times. Then, the long diameter and the short diameter for any 50 particles are measured, and the primary particle diameter that is the average value of measurements is calculated, and the average value thereof then is calculated.

<2> The specific surface area of the molybdenum oxide powder is measured by a specific surface area measuring device that uses a gas adsorption method such as the BET method. In addition, the density of the molybdenum oxide powder is measured by a true density measuring device that uses a gas displacement method. The primary particle diameter of the molybdenum oxide powder is then calculated using (Equation 1) as described below.

Specific surface area (m²/g)=6,000/ρd (Equation 1)

(In (Equation 1), ρ represents a density (g/cm³); and d represents a primary particle diameter (nm).)

The molybdenum trioxide powder obtained by the method for recovering the molybdenum compound of the present embodiment has a high purity and a large specific surface area as measured by the BET method, so it can be reused for various applications. For example, it can be suitably used as a flux in a case of producing inorganic oxides such as alumina, zirconia, titania, and silica using the fluxing method. The molybdenum trioxide powder has a large specific surface area, therefore it can also be suitable for use as an antimicrobial agent, an antiviral agent, and the like. Furthermore, it can also be used as a raw material for the molybdenum compound having a high purity and a large specific surface area as measured by the BET method. Therefore, the method for recovering a molybdenum compound of the present embodiment can contribute to the reuse of the molybdenum compound and reduce the burden on the environment.

### EXAMPLES

Hereinafter, the present invention will be more specifically described with reference to Examples. Note that the present invention is not limited only to the following Examples.

### Example 1

As the molybdenum component-containing solution, a waste liquid which was generated by washing alumina after firing with water and contained potassium molybdate used as a flux when firing alumina, was prepared. Therefore, the molybdenum component-containing solution used in Example 1 is a solution in which potassium molybdate is dissolved in an aqueous medium containing water.

The residue obtained by drying the molybdenum component-containing solution was analyzed using an X-ray fluorescence spectrometer (XRF) (trade name; Primus IV; manufactured by Rigaku Corporation). Using the obtained results, the molybdenum content (molybdenum trioxide equivalent) contained in the molybdenum component-containing solution was calculated. As a result, the molybdenum content (molybdenum trioxide equivalent) in the molybdenum component-containing solution used in Example 1 was 6.85% by mass.

### (Precipitating Process)

To 5,000 g of the molybdenum component-containing solution, 750 g of a basic polyaluminum chloride aqueous solution (manufactured by Taimei Chemical Co., Ltd.; Taipack) was added as a precipitation accelerator while stirring using a mechanical stirrer, and the mixture was further stirred. Subsequently, the pH of the molybdenum component-containing solution was adjusted to 9 by adding potassium hydroxide as a pH adjuster and stirring to precipitate a white deposition.

Subsequently, the molybdenum component-containing solution from which the white deposition was deposited was subjected to suction filtration while adding ion-exchanged water, thereby the white deposition was washed, separated from the medium, and then recovered. The recovered white deposition was then dried to make into the powder.

The precipitate in Example 1, which was a white deposition that was dried to make into the powder, was identified by the following method. First, the precipitate in Example 1 was subjected to an elementary analysis using an X-ray fluorescence spectrometer (XRF) (trade name; Primus IV; manufactured by Rigaku Corporation). In addition, the precipitate in Example 1 was subjected to the heat treatment at 600° C. for 1 hour and the resultant was analyzed using an X-ray diffractometer (XRD) (trade name; Ultima IV; manufactured by Rigaku Corporation). The component of the precipitates in Example 1 was then confirmed based on the elemental ratios obtained from the results of elementary analysis by XRF and the spectrum intensities obtained from the XRD results. As a result, it was confirmed that the precipitate in Example 1 was a mixture of alumina (Al₂O₃) and aluminum molybdate (Al₂(MoO₄)₃).

### (Firing Process)

Next, the white deposition, which was recovered from the molybdenum component-containing solution and made into the powder, was placed in a heat treatment furnace and heated under the firing conditions described below. That is, the temperature was raised from normal temperature to 1,100° C. in an air atmosphere at a temperature rising rate of 5° C./minute, the temperature was maintained at 1,100° C. for 10 hours at normal pressure without pressure control, and then allowed to naturally cool to decrease the temperature to normal temperature.

The fired product was recovered from inside the heat treatment furnace after the firing process and identified by a method similar to that of the precipitate in Example 1. As a result, it was confirmed that the fired product in Example 1 was a mixture of alumina (Al₂O₃) and molybdenum oxide (MoO₃).

### (Cooling Process) (Recovering Process)

On the other hand, in the firing process, the vapor produced in the heat treatment furnace was discharged from the heat treatment furnace and supplied into the cooling pipe, and the vapor was cooled in the cooling pipe to make into the powder so that the cooling rate of the vapor in a temperature range of 1,100° C. that is the highest temperature when thermally decomposing the molybdate in Example 1 to 800° C., was 2,000° C./second, and 270 g of the powder was recovered.

The powder recovered by the recovering method in Example 1 was identified by the method for performing the X-ray diffraction (XRD) measurement and the purity thereof was calculated by the X-ray fluorescence analysis (XRF). As a result, it was confirmed that the powder recovered by the recovering method in Example 1 (vapor produced in the firing process) was molybdenum trioxide (MoO₃) and its purity was 99.7%.

In addition, the recovery rate of the powder recovered by the recovering method in Example 1 was calculated using the following (Equation 2). As a result, the recovery rate was 78.8%.

$$Recovery rate ( \% ) = \{ ( Mo content II / Mo content I ) \times 100 \} \qquad ( Equation 2 )$$

(In (Equation 2), Mo content I is the molybdenum content (molybdenum trioxide equivalent) (g) contained in the molybdenum component-containing solution; and Mo content II is the molybdenum content (molybdenum trioxide equivalent) (g) in the recovered powder.)

In addition, the specific surface area as measured by the BET method, and the average particle diameter of the primary particles were measured for the powder recovered by the recovering method in Example 1, by the method described below. As a result, the specific surface area measured by the BET method was 50 m²/g, and the average particle diameter of the primary particles was 30 nm.

### [Measurement Method of Specific Surface Area: BET Method]

Using a specific surface area meter (manufactured by MicrotracBEL Corp., BELSORP-MINI), the adsorption amount of nitrogen gas by the BET method was measured for the powder recovered by the recovering method in Example 1, and the surface area per gram of a sample was calculated from the obtained results to determine the specific surface area (m²/g) of the powder recovered by the recovering method in Example 1.

### [Method for Measuring Average Particle Diameter of Primary Particles]

The powder recovered by the recovering method in Example 1 was photographed with a transmission electron microscope (TEM; manufactured by JEOL Ltd.; JEM-1400). For the smallest unit of particles constituting an agglomerate (that is, primary particles) on the obtained two-dimensional image, the long diameter (Feret's diameter of the longest portion observed) and the short diameter (short Feret's diameter perpendicular relative to the Feret's diameter of the longest portion) were measured, and the average value of these was used as the primary particle diameter. The similar operation was performed on 50 primary particles that were randomly selected, and the average value of the primary particle diameters of the 50 primary particles was calculated to be the average particle diameter of the primary particles of the powder recovered by the recovering method in Example 1.

### Example 2

The precipitating process, firing process, cooling process, and recovering process were performed in the similar manner to those in Example 1, except that a 10% by weight of sodium molybdate aqueous solution (the molybdenum content (molybdenum trioxide equivalent) is 7% by weight) prepared by adding 4412.5 g of ion-exchanged water to 587.5 g of sodium molybdate dihydrate (reagent, manufactured by KANTO CHEMICAL CO., INC.) was used as a molybdenum component-containing solution. In addition, the precipitate produced in the precipitating process and the fired product were identified by the method similar to that in Example 1.

As a result, the precipitate in Example 2 was a mixture of alumina (Al₂O₃) and aluminum molybdate (Al₂(MoO₄)₃). In addition, the fired product obtained in Example 2 was a mixture of alumina (Al₂O₃) and molybdenum oxide (MoO₃).

In addition, in Example 2, the mass of MoO₃ recovered by cooling in the cooling pipe was 260 g, and the recovery rate thereof was 74.3%.

### Example 3

The precipitating process, firing process, cooling process, and recovering process were performed in the similar manner to those in Example 1, except that 940 g of an aluminum sulfate aqueous solution (manufactured by Taimei Chemical Co., Ltd.) was used instead of a basic polyaluminum chloride aqueous solution as a precipitation accelerator. In addition, the precipitate produced in the precipitating process and the fired product were identified by the method similar to that in Example 1.

As a result, the precipitate produced in the precipitating process in Example 3 was a mixture of alumina (Al₂O₃) and aluminum molybdate (Al₂(MoO₄)₃). In addition, the fired product obtained in Example 3 was a mixture of alumina (Al₂O₃) and molybdenum oxide (MoO₃).

In addition, in Example 3, the mass of MoO₃ recovered by cooling in the cooling pipe was 210 g, and the recovery rate thereof was 61.3%.

### Comparative Example 1

The same molybdenum component-containing solution as used in the recovering method in Example 1 was prepared.

### (Precipitating Process)

The pH of the molybdenum component-containing solution was adjusted to 9 by adding potassium hydroxide as a pH adjuster to 1,000 g of the molybdenum component-containing solution and stirring. To the molybdenum component-containing solution after the pH was adjusted, 300 g of an aqueous solution of calcium chloride (reagent, manufactured by Kanto Chemical Co., Ltd.) prepared at 10% by mass with ion-exchange water as a precipitation accelerator was added while stirring using a mechanical stirrer, and the mixture was further stirred, resulting in precipitating a white deposition.

Subsequently, the molybdenum component-containing solution from which the white deposition was deposited was subjected to suction filtration in the similar manner to the recovering method in Example 1, thereby the white precipitate was recovered, dried, and then made into the powder.

The precipitate of Comparative Example 1, which was a white deposition that was dried to make into the powder, was identified by a method similar to that of the precipitate in Example 1. As a result, it was confirmed that the precipitate in Comparative Example 1 was a mixture of calcia (CaO) and calcium molybdate (CaMoO₄).

### (Firing Process), (Cooling Process), and (Recovering Process)

The firing process, cooling process, and recovering process were then performed in the similar manner to the recovering method in Example 1, except that the white deposition that was dried to make into the powder, obtained in the precipitating process of Comparative Example 1 was used instead of the white deposition that was dried to make into the powder, obtained in the precipitating process in Example 1.

The fired product was recovered from inside the heat treatment furnace after the firing process and identified by a method similar to that of the precipitate in Example 1. As a result, it was confirmed that the fired product in Comparative Example 1 was a mixture of calcia (CaO) and calcium molybdate (CaMoO₄).

In addition, in Comparative Example 1, it was observed no vapor was produced in the heat treatment furnace in the firing process, and no powder was produced in the cooling pipe in the cooling process.

The molybdenum contents (molybdenum trioxide equivalent) for the precipitates obtained in the precipitating process of the recovering methods and the fired products recovered from inside the heat treatment furnace after the firing process, in Examples 1 to 3 and Comparative Example 1, were measured based on the results of elementary analysis by the X-ray fluorescence analysis (XRF), respectively. The results are listed in Tables 1 and 2.

Also, “Precipitation accelerator”, “pH of molybdenum component-containing solution”, “A in molybdate represented by formula (1)”, “Component of precipitate precipitated in precipitating process”, and “Molybdenum content in precipitate (MoO₃ equivalent)” used in the recovering methods in Examples 1 to 3 and Comparative Example 1 described above are listed in Table 1.

TABLE 1

| | | pH of | | | | Mo content |
|---|---|---|---|---|---|---|
| | | molybdenum | | | | in precipitate |
| | | component- | A in | | | (MoO₃ |
| | Precipitation | containing | formula | Component of | | equivalent) |
| | accelerator | solution | (1) | precipitate | | (% by mass) |
| Example 1 | Basic | 9 | Al | Al₂(MoO₄)₃ | Al₂O₃ | 68.0 |
| | polyaluminum | | | | | |
| | chloride | | | | | |
| | aqueous | | | | | |
| | solution | | | | | |
| Example 2 | Basic | 9 | Al | Al₂(MoO₄)₃ | Al₂O₃ | 70.1 |
| | polyaluminum | | | | | |
| | chloride | | | | | |
| | aqueous | | | | | |
| | solution | | | | | |
| Example 3 | Aluminum | 9 | Al | Al₂(MoO₄)₃ | Al₂O₃ | 64.6 |
| | sulfate aqueous | | | | | |
| | solution | | | | | |
| Comparative | Calcium | 9 | — | CaMoO₄ | CaO | 71.8 |
| Example 1 | chloride | | | | | |

“Component of fired product”, “Molybdenum content in fired product (MoO₃ equivalent)”, and “Purity”, “Specific surface area”, “Average particle diameter of primary particles”, and “Recovery rate” of MoO₃ recovered by cooling in the cooling pipe, which were produced in the firing process of the recovering method in Example 1, are listed in Table 2.

TABLE 2

| | | | | MoO₃ recovered by cooling in cooling pipe | | | |
|---|---|---|---|---|---|---|---|
| | | | Mo content | | | Average | |
| | | | in fired | | | particle | |
| | | | product | | Specific | diameter of | |
| | Component of | | (MoO₃ | | surface | primary | Recovery |
| | fired product | | equivalent) | Purity | area | particles | rate |
| | (% by mass) | | (% by mass) | (%) | (m²/g) | (nm) | (%) |
| Example 1 | MoO₃ | Al₂O₃ | 0.8 | 99.7 | 50 | 30 | 78.8 |
| Example 2 | MoO₃ | Al₂O₃ | 3.1 | 99.5 | 42 | 28 | 74.3 |
| Example 3 | MoO₃ | Al₂O₃ | 8.3 | 99.4 | 35 | 35 | 61.3 |
| Comparative | CaMoO₄ | CaO | 71.8 | — | — | — | — |
| Example 1 | | | | | | | |

As listed in Table 2, for the recovering methods of Examples 1 to 3, the molybdenum oxide powder having a high purity, a large specific surface area, and a small average particle diameter of primary particles, was able to be recovered from the molybdenum component-containing solutions. In addition, the recovery rates in the recovering methods of Examples 1 to 3 were 60% or more, and it was confirmed that molybdenum trioxide was able to be recovered from the molybdenum component-containing solutions at high recovery rates. This is due to the fact that, in Examples 1 to 3, Al₂(MoO₄)₃ precipitated in the precipitating process was thermally decomposed in the firing process to produce the vapor containing molybdenum trioxide.

In contrast, in the recovering method of Comparative Example 1, CaMoO₄ precipitated in the precipitating process was not thermally decomposed in the firing process, therefore no vapor containing molybdenum trioxide was produced, resulting in not recovering molybdenum trioxide.

By the method of recovering a molybdenum compound of the present invention, the powder containing molybdenum trioxide having a high purity and a large specific surface area as measured by the BET method can be obtained from the molybdenum component-containing solution. Therefore, the recovered molybdenum trioxide, for example, can be preferably used as a flux in a case of producing inorganic oxides such as alumina, zirconia, titania, and silica using the fluxing method, and can also be reused for various applications. Therefore, the method for recovering a molybdenum compound of the present invention can contribute to the reuse of the molybdenum compound and reduce the burden on the environment.

What is claimed is:

1. A method for recovering a molybdenum compound, the method comprising:
precipitating, in a molybdenum component-containing solution, a molybdate represented by AₓMo_{y}O_{3y+z} (1), wherein A represents an element selected from Group 4, Group 8, Group 12, Group 13, and Group 14; 3y+z represents the number of oxygen atoms contained in the molybdate; and z represents the number of ½ the valence number of A×x;
firing comprising producing an oxide represented by AO_{z}(2), wherein A is same as A in the formula (1); and z represents the number of oxygen atoms that combine with A in the formula (2) to produce an oxide, and producing vapor containing molybdenum trioxide, by thermally decomposing the molybdate;
cooling the vapor containing molybdenum trioxide to produce powder containing molybdenum trioxide; and
recovering the powder containing molybdenum trioxide.

2. The method for recovering a molybdenum compound according to claim 1, wherein, in the precipitating, a precipitation accelerator containing a compound containing one or more kinds of elements selected from Group 4, Group 8, Group 12, Group 13, and Group 14 elements is added to the molybdenum component-containing solution and a resultant mixture is stirred to precipitate the molybdate.

3. The method for recovering a molybdenum compound according to claim 1, wherein, in the precipitating, a precipitation accelerator containing an aluminum compound is added to the molybdenum component-containing solution and a resultant mixture is stirred to precipitate the molybdate.

4. The method for recovering a molybdenum compound according to claim 1, wherein, in the precipitating, a precipitation accelerator containing polyaluminum chloride is added to the molybdenum component-containing solution and a resultant mixture is stirred to precipitate the molybdate.

5. The method for recovering a molybdenum compound according to claim 4, wherein a pH of the molybdenum component-containing solution to which a precipitation accelerator containing polyaluminum chloride is added is adjusted to be in a range of 8 to 13.

6. The method for recovering a molybdenum compound according to claim 1, wherein, in the recovering, molybdenum trioxide powder having a purity of 99% or more and a specific surface area of 20 m²/g or more as measured by the BET method is recovered.
